(19) United States
(12) Patent Application Publication
(10) Pub. No.: US 2025/0277941 A1
(43) Pub. Date: Sep. 4, 2025

(54) LOOPBACK DUST CAP FOR FIBER OPTIC CABLE ASSEMBLY AND METHOD OF MAKING SAME

(71) Applicant: CORNING RESEARCH & DEVELOPMENT CORPORATION, Corning, NY (US)

(72) Inventors: Laura Anne Blair, Keller, TX (US); Ashley Wesley Jones, Denton, TX (US)

(21) Appl. No.: 19/060,890

(22) Filed: Feb. 24, 2025

Related U.S. Application Data
(60) Provisional application No. 63/560,981, filed on Mar. 4, 2024.

(51) Int. Cl. G02B 6/38

(52) U.S. Cl. CPC G02B 6/3849; G02B 6/3874

(57) ABSTRACT

A loopback dust cap for a fiber optic cable assembly includes a body and an inserted received in a cavity of the body. The insert supports first and second sleeves, which in turn support first and second cap ferrules that terminate opposite ends of a loopback optical fiber that extends within the body to form a loopback. The first and second sleeves are configured to align ferrules of a fiber optic connector with the first and second cap ferrules and thereby allow the loopback optical fiber to receive and return optical signals to the fiber optic connector.

### PRIORITY APPLICATION

This application claims the benefit of priority of U.S. Provisional Application No. 63/560,981, filed on Mar. 4, 2024, the content of which is relied upon and incorporated herein by reference in its entirety.

### TECHNICAL FIELD

This disclosure relates generally to optical connectivity, and more particularly to a method and device for testing fiber optic cables.

### BACKGROUND

Optical fibers are useful in a wide variety of applications, including the telecommunications industry for voice, video, and data transmissions. Benefits of optical fibers include wide bandwidth and low noise operation. Continued growth of the Internet has generated demand for data centers having larger numbers of computer systems and associated telecommunication and storage systems. These systems are often connected by one or more fiber optic cables that were installed well before the systems. If a fiber optic cable has excessive signal loss (e.g., due to unlatched or dirty connectors, a severely bent fiber, or any other reason) the systems connected by that fiber optic cable may not function properly. When a technician becomes aware of a problematic optical link, they must identify the fiber optic cable providing the link, track down each end of the fiber optic cable, and then test the fiber optic cable, e.g., using a power meter or installed hardware (e.g., switch) to determine if there is excessive signal loss.

In large data centers having thousands of fiber optic cables, finding and testing a fiber optic cable providing a defective link between network nodes can be time consuming. Thus, there is a need in the fiber optic industry for improved methods and devices for evaluating fiber optic cables prior to the cables being used to connect network nodes.

### SUMMARY

The present disclosure provides a loopback dust cap and methods of using the loopback dust cap. The loopback dust cap is intended for a fiber optic cable assembly that includes a first optical fiber, a second optical fiber, and a fiber optic connector having a first connector ferrule that terminates the first optical fiber and a second connector ferrule that terminates the second optical fiber. According to one embodiment, the loopback dust cap includes a body that has a front end, a back end, and a cavity between the front end and the back end. The back end of the body includes an opening into the cavity so that the cavity is configured to receive the fiber optic connector. The loopback dust cap also includes an insert received in the cavity of the body and first and second sleeves that are supported by the insert. Each of the first and second sleeves includes a respective first end facing the front end of the body and a respective second end facing the back end of the body. A first cap ferrule extends through the first end of the first sleeve and includes a first end face positioned within the first sleeve. A second cap ferrule extends through the first end of the second sleeve and includes a second end face positioned within the second sleeve. The loopback dust cap also includes a loopback optical fiber having a first end terminated by the first cap ferrule and a second end terminated by the cap second ferrule. The loopback optical fiber extends between the first cap ferrule and the second cap ferrule in a region of the body that is between the front end of the body and the insert. The first sleeve and the second sleeve are configured to: (i) receive the first connector ferrule and the second connector ferrule, respectively, when the fiber optic connector is received in the cavity; and (ii) align the first connector ferrule and the second connector ferrule with the first cap ferrule and the second cap ferrule, respectively.

The body and insert of the loopback dust cap may be configured to define a mating interface similar to a fiber optic adapter. In some embodiments, for example, the body and the insert may be shaped to define an LC-type interface according to IEC 61754-20:2012 or TIA-604-10-C. Regardless of whether an intermatability interface is defined, in some embodiments the first cap ferrule and the second cap ferrule may each comprise a ceramic ferrule having a nominal diameter of 1.25 mm.

In some embodiments, the loopback dust cap further includes: a first ferrule holder received over a portion of the first cap ferrule that is not within the first sleeve; and a second ferrule holder received over a portion of the second cap ferrule that is not within the second sleeve. The first ferrule holder and the second ferrule holder are at least partially retained within the insert. One possible way to achieve this is for the insert to include a support wall, a first boss extending from the support wall toward the front end of the body, and a second boss extending from the support wall toward the front end of the body. The first boss extends over and beyond the first end of the first sleeve, and receives and retains at least a portion of the first ferrule holder. The second boss extends over and beyond the first end of the second sleeve, and receives and retains at least a portion of the second ferrule holder. Optionally, the first boss and the second boss may each comprise respective split end portions configured to expand radially to allow insertion of the first ferrule holder and the second ferrule holder, respectively, when the insert is not received in the cavity. In such embodiments the body may be configured to limit or prevent the split end portions from expanding radially when the insert is received in the cavity.

In some embodiments, the loopback optical fiber may meet bend performance specifications of International Telecommunication Union standards ITU-T G.657.A2 and/or ITU-T G.657.B2. In other embodiments, the loopback optical fiber may meet bend performance specifications of International Telecommunication Union standard ITU-T G.657.B3.

According to another aspect of this disclosure, the body of the loopback dust cap may comprise a translucent or transparent material, and the loopback optical fiber may be configured to emit visible light.

A fiber optic cable assembly including the loopback dust cap is also provided in this disclosure. The fiber optic cable assembly comprises: a first optical fiber and a second optical fiber; a fiber optic connector having a first connector ferrule that terminates the first optical fiber and a second connector ferrule that terminates the second optical fiber; and the loopback dust cap (e.g., such as described in the above paragraphs of this Summary section). The first connector ferrule extends into the first sleeve of the loopback dust cap and contacts the end face of the first cap ferrule, and the second connector ferrule extends into the second sleeve of the loopback dust cap and contacts the end face of the second cap ferrule.

A method of making a loopback dust cap is also provided in this disclosure, with the loopback dust cap being for a fiber optic cable assembly that includes a first optical fiber, a second optical fiber, and a fiber optic connector having a first connector ferrule that terminates the first optical fiber and a second connector ferrule that terminates the second optical fiber. The method comprises: (a) assembling first and second sleeves with an insert so that the first and second sleeves are supported by the insert; (b) providing a loopback assembly that includes a loopback optical fiber having one end terminated by a first cap ferrule and another end terminated by a second cap ferrule; (c) extending the first cap ferrule through a first end of the first sleeve so that an end face of the first cap ferrule is positioned within the first sleeve; (d) extending the second cap ferrule through a first end of the second sleeve so that an end face of the second cap ferrule is positioned within the second sleeve; and (e) positioning the insert in a cavity of a body. The body includes a front end and a back end, and the back end includes an opening into the cavity. The positioning step (e) occurs after steps (a)-(d) so that the positioning results in: (i) the respective first ends of the first and second sleeves facing the front end of the body and respective second ends of the first and second sleeves facing the back end of the body, and (ii) the loopback optical fiber extending between the first cap ferrule and the second cap ferrule in a region of the body that is between the front end of the body and the insert. The cavity of the body is configured to receive the fiber optic connector through the opening in the back end of the body. Additionally, the first sleeve and the second sleeve are configured to: (i) receive the first connector ferrule and the second connector ferrule, respectively, when the fiber optic connector is received in the cavity, and (ii) align the first connector ferrule and the second connector ferrule with the first cap ferrule and the second cap ferrule, respectively.

Additional features and advantages will be set out in the detailed description which follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is perspective view of an exemplary fiber optic connector with a loopback dust cap according to one embodiment of this disclosure.

FIG. 2 is an exploded perspective view of the exemplary fiber optic connector and loopback dust cap of FIG. 1, with the loopback dust cap itself being exploded into a cap and an insert sub-assembly.

FIG. 3 is an exploded perspective view of the insert sub-assembly of FIG. 2.

FIG. 4 is a cross-sectional view of a portion of the insert sub-assembly of FIG. 2.

FIG. 5 is a different cross-sectional view of the insert sub-assembly of FIG. 2.

FIGS. 6 and 7 are perspective views showing how the insert sub-assembly of FIG. 2 can be received in a cavity of the body of the loopback dust cap.

FIG. 8 is a perspective view of an underside of the insert sub-assembly of FIG. 2 prior to positioning the insert sub-assembly in the body.

FIG. 9 is a cross-sectional view of the loopback dust cap of FIG. 1 installed on the fiber optic connector, wherein only a portion of the fiber optic connector is shown.

### DETAILED DESCRIPTION

Various embodiments will be further clarified by examples in the description below. In general, the description relates to a loopback dust cap for a fiber optic cable assembly that provides an optical loopback which can be used for testing the fiber optic cable assembly and/or an optical link that includes the fiber optic cable assembly. For example, the loopback dust cap may be configured to receive an optical signal (e.g., a 1300 nm optical signal) transmitted down one optical fiber of a fiber optic cable assembly to which the loopback dust cap is attached, and redirect the received optical signal down another optical fiber of the fiber optic cable assembly. The loopback dust cap may thereby provide a loopback to the device (e.g., transceiver) transmitting the optical signal at an opposite end of the fiber optic cable assembly or opposite end of an optical link that includes the fiber optic cable assembly.

The amount of attenuation in the optical loopback can be determined by comparing the power of the return optical signal to the power of the transmitted optical signal. Attenuation issues in an optical link that includes the fiber optic cable assembly, such as issues that may be caused by the presence of debris or loose connections, can then be identified based on the amount of attenuation. In one embodiment, the loopback dust cap may have a simplified construction, comprising just two primary molded components—a body and an insert—that can be assembled together, with insert configured to hold a loopback assembly that fits within the body.

Loopback dust caps and methods of using loopback dust caps to evaluate optical links may be particularly useful in data center systems. Data centers often include duplex optical links in which optical signals are transmitted by one optical fiber and received by another optical fiber. In this environment, loopback dust caps can be placed at one end of a duplex link so that the transmitted signal is returned as the received signal, which can then be measured at the other end, e.g., at a transceiver. Data center optical links often include multiple jumpers, modules, trunk cables, and harnesses. When a loopback dust cap is installed at the end of an optical link, the loopback feature may facilitate determining the loss through that optical link. By comparing losses between optical links, a technician may identify an optical link having a higher-than-normal loss as having a problem. For example, if a relatively large number of optical links (e.g., 99 links) have a relatively low loss (e.g., a loss of less than 1.5 dB), and only a few optical links (e.g., one link) have a relatively high loss (e.g., a loss in excess of 4 dB), the optical links with the outlying attenuations likely have problems.

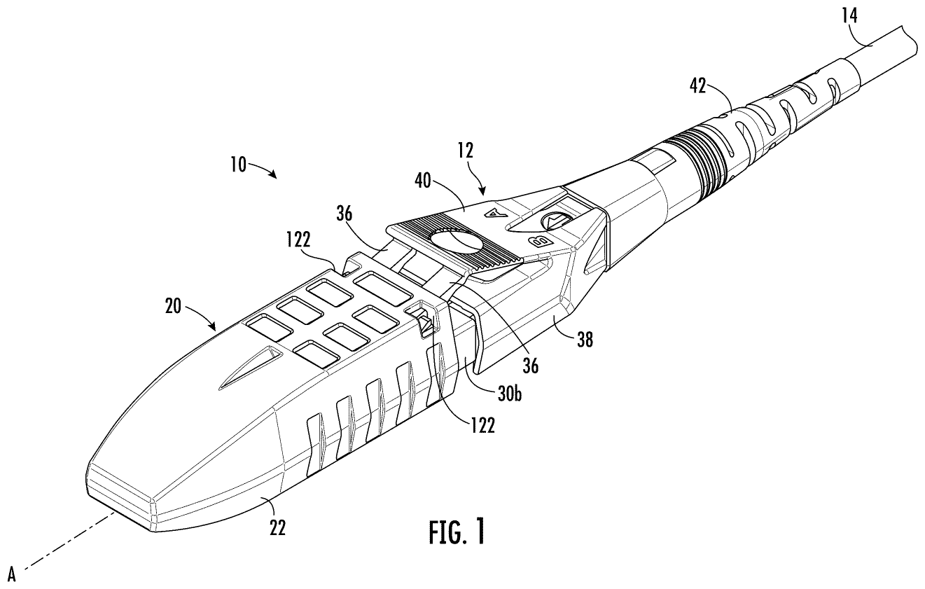

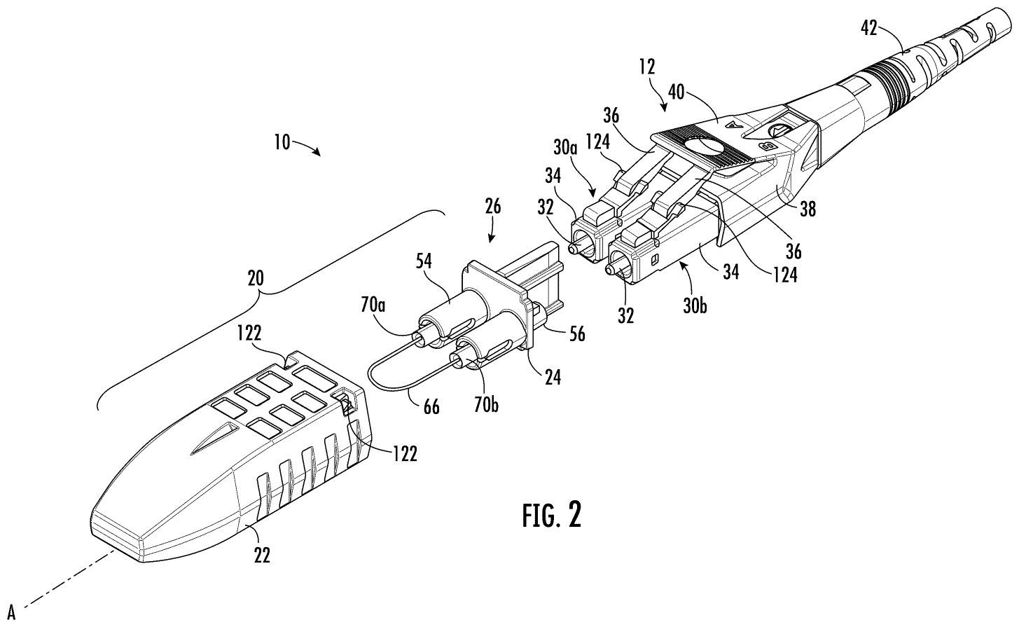

FIGS. 1 and 2 illustrate an example embodiment of a fiber optic cable assembly 10 together with a loopback dust cap 20 according to this disclosure. More specifically, FIG. 1 illustrates an end portion of the fiber optic cable assembly 10 that includes a fiber optic connector 12 (“connector 12”) terminating a fiber optic cable 14. The loopback dust cap 20 is received on the end of the connector 12. In FIG. 2, the loopback dust cap 20 is shown removed from the connector 12 and in a partially exploded form. The loopback dust cap 20 includes the two primary molded components mentioned above: a body 22 (or “shell 22”) and an insert 24. The insert 24 is part of an insert sub-assembly 26, which will be described in greater detail below.

The connector 12 is shown in the form of a form of a duplex LC connector (e.g., according to IEC standard 61754-20:2012 and/or TIA 607-10-C). Accordingly, the loopback dust cap 20 can be considered a duplex LC dust cap since it is configured to be received on the connector 12. However, the present disclosure is not limited to such types of connectors and dust caps, as persons skilled in optical connectivity will appreciate that many other embodiments are possible. For example, the principles described below for the loopback dust cap 20 may apply to dust cap designs for other duplex connectors, including very small form factor (VSFF) duplex connectors such as SN connectors commercially available from Senko Advanced Components, Inc. and MDC connectors commercially available from US Conec Ltd.

The connector 12 includes two connector sub-assemblies 30a, 30b that each have a ferrule 32 (also referred to herein as “connector ferrule 32”) extending from a connector body 34. The connector ferrules 32 terminate different optical fibers that are carried by the fiber optic cable 14, as is well known. The connector bodies 34 each include a latch arm 36 for engaging an adapter or receptacle (not shown), as is also well-known. The other components of the connector 12 in FIGS. 1 and 2, including a shell 38, a common housing (hidden from view in FIGS. 1 and 2) covered by the shell 38, trigger 40 for actuating the latch arms 36, and boot 42, are not pertinent to this disclosure and will not be described. Again, the connector 12 is merely an example of a connector for a loopback dust cap according to this disclosure. The loopback dust cap 20 may be used with other designs of duplex LC connectors, and embodiments are possible for other types of connectors such as SN and MDC connectors.

The connector 12 generally extends along a longitudinal axis A centered between the connector sub-assemblies 30a, 30b. In this disclosure, references to an “axial direction”, “axially”, or the like refer to along or parallel to the longitudinal axis A. Furthermore, the terms “front” and “back” (or “rear”) are relative terms that generally use the orientation of the connector 12 along the longitudinal axis A as a reference. For example, a front of the connector 12 is defined by the connector sub-assemblies 30a, 30b (and specifically the connector ferrules 32), and a rear of the connector 12 is defined where the boot 42 of the connector 12 stops extending over the cable 14. The loopback dust cap 20 is described below with the same orientation in mind. In other words, a front of the loopback dust cap 20 faces the same direction as the front of the connector 12, and a back of the loopback dust cap 20 faces the same direction as the rear of the connector 12.

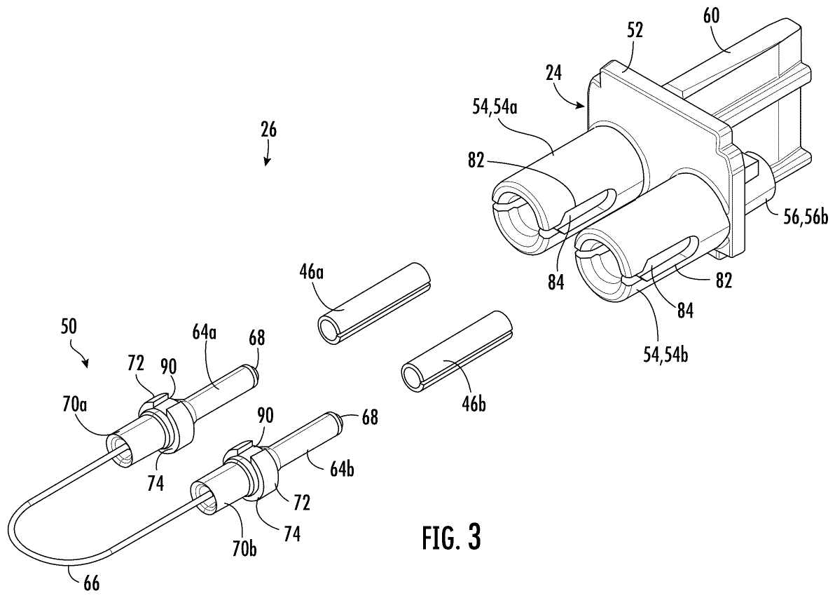

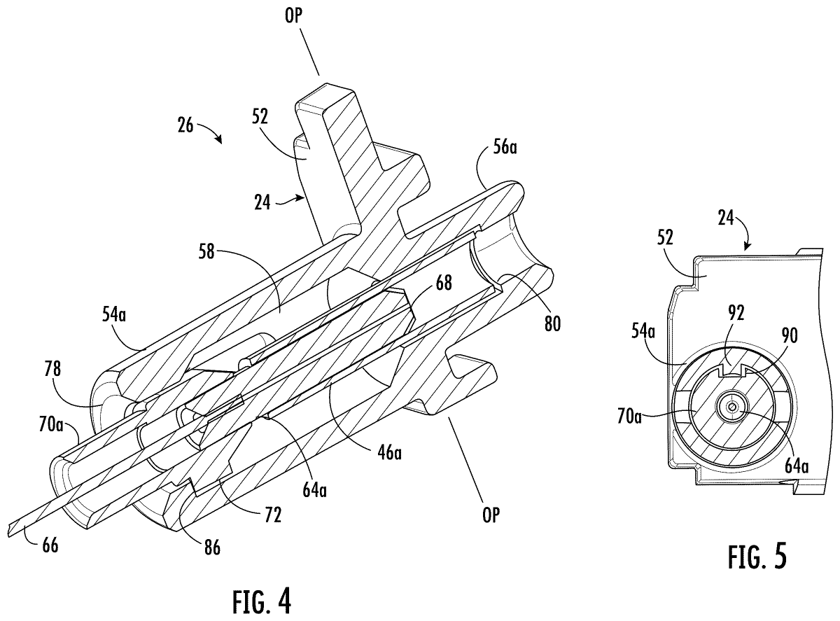

The loopback dust cap 20 includes the body 22 and insert sub-assembly 26, as mentioned above. FIG. 3 illustrates the components of the insert sub-assembly 26 in further detail. As shown in FIG. 3, the insert sub-assembly 26 includes the insert 24, first and second sleeves 46a, 46b, and a loopback assembly 50. The insert 24 may be a molded component with a main support wall 52 and bosses 54, 56 extending from opposite sides of the support wall 52. More specifically, first and second bosses 54a, 54b extend from a front side of the support wall 52, and another pair of bosses 56a, 56b (only one boss 56b being visible in FIG. 3) extend from a back side of the support wall 52. The first boss 54a is aligned with one of the bosses 56a on the back side of the support wall 52, and the second boss 54b is aligned with the other boss 56b on the back side of the support wall 52. This allows each aligned pair of bosses 54, 56 to define different portions of a continuous passage 58 (FIG. 4) that also extends through the support wall 52. The bosses 54, 56 are generally cylindrical in the embodiment shown and help guide ferrules (including the connector ferrules 32) into the first and second sleeves 46a, 46b, as will be described in greater detail below. To this end, the insert 24 may be similar to inserts used in fiber optic adapters (or to internal portions of a one-piece, molded adapter body). The insert 24 may also include a divider wall 60 that extends from the back side of the support wall 52 between the bosses 56a, 56b.

The first and second sleeves 46a, 46b may be slit sleeves like those commonly used in fiber optic adapters for aligning the ferrules of two mated fiber optic connectors. Although shown exploded from the insert 24 in FIG. 3, the first and second sleeves 46a, 46b are normally received in the passages 58 (FIG. 4) of the insert 24 and supported by the bosses 56a, 56b. In other embodiments, the bosses 54 may be configured to support first and second sleeves 46a, 46b instead of or in addition to the bosses 56a, 56b.

The loopback assembly 50 includes first and second cap ferrules 64a, 64b that terminate opposite ends of a loopback optical fiber 66. In the embodiment shown, the first and second cap ferrules 64a, 64b are ceramic ferrules that have a nominal diameter of 1.25 mm, similar to the connector ferrules 32 (as is known for LC-type connectors and many other types of connectors that use similar ferrules). The first and second cap ferrules 64a, 64b are configured to be received in the first and second sleeves 46a, 46b, respectively, and each include an end face 68 that presents an end of the loopback optical fiber 66 for optical coupling. The first and second cap ferrules 64a, 64b extend along respective first and second optical axes when the loopback dust cap 20 is assembled. The loopback assembly 50 also includes first and second ferrule holders 70a, 70b from which the first and second cap ferrules 64a, 64b extend. Thus, the ferrule holders 70a, 70b receive and support end portions of the first and second cap ferrules 64a, 64b. Each ferrule holder 70a, 70b includes a flange portion 72 that defines an axially-facing seating/flange surface 74.

FIG. 4 is a cross-sectional view of a portion of the insert sub-assembly 26 in an assembled state, and shows the relationship between the first cap ferrule 64a, first ferrule holder 70a, first sleeve 46a, and bosses 54a, 56a. Although not shown in FIG. 4, the second cap ferrule 64b, second ferrule holder 70b, second sleeve 46b, and bosses 54b, 56b are arranged in a similar manner. Thus, the following description of FIG. 4 applies equally to the second cap ferrule 64b, second ferrule holder 70b, second sleeve 46b, and bosses 54b, 56b.

As shown in FIG. 4, the support wall 52 and boss 54a support a portion of the first sleeve 46a, with a remainder of the first sleeve 46a extending within the first boss 54a. The first sleeve 46a may, for example, be inserted into the passage 58 through an end of the first boss 54a (which defines an opening 78 into the passage 58) and advanced through the support wall 52 and into the boss 56a during an assembly process. The boss 56a includes an internal shoulder 80 (or “stop 80”) that the first sleeve 46a abuts to position the first sleeve 46a within the insert 24.

The portion of the first sleeve 46a that extends within the first boss 54a receives and supports the first cap ferrule 64a, as shown in FIG. 4. The first ferrule holder 70a is also at least partially positioned within the passage 58. Although the opening 78 into the passage 58 is smaller than the flange portion 72 of the first ferrule holder 70a, the first boss 54a includes a split end portion 82 (FIG. 3) to allow the flange portion 72 to be inserted through the opening 78 and into the passage 58. The split end portion 82 effectively is formed by slots 84 (two in the embodiment shown) that extend from the end of the first boss 54a toward the support wall 52. The slots 84 split the end portion 82 of the first boss 54a into different arcuate segments so that the first boss 54a can expand radially to allow the first ferrule holder 70a to be inserted into the passage 58 until the flange portion 72 reaches a larger-diameter section of the passage 58, at which point the first boss 54a can return to its non-expanded configuration. The change in diameter of the passage 58 defines an internal shoulder 86 (or “stop 86”) in the first boss 54a.

As shown in FIG. 4, in an assembled configuration, the seating surface 74 of the first ferrule holder 70a faces the internal shoulder 86 of the first boss 54a. When the seating surface 74 contacts the internal shoulder 86, the end face 68 of the first cap ferrule 64a is positioned at or substantially at an optical reference plane OP that is transverse to the axial direction. The optical reference plane OP will be discussed in further detail below in connection with the loopback dust cap 20 being received on the connector 12. Persons skilled in optical connectivity, however, will appreciate how the first ferrule holder 70a has a fixed relationship with the first cap ferrule 64a, and that the seating surface 74 serves as a mechanical reference or datum relative to the end face 68 of the first cap ferrule 64a. The first boss 54a can then be designed so that the internal shoulder 86 positions the end face 68 of the first cap ferrule 64a at or substantially at a desired plane (the optical reference plane OP) when the seating surface 74 of the first ferrule holder 70a contacts the internal shoulder 86.

The cross-section of the first ferrule holder 74a in FIG. 4 shows the seating surface 74 on the bottom of the flange portion 72 but not the top. This is due to the plane of the cross-section extending through a notch or keyway 90 (FIG. 3) that is provided on the top of the first ferrule holder 70a. As shown in FIG. 5, the first boss 54a includes a keying feature 92 that is received in the keyway 90 to limit the first ferrule holder 70a from rotating relative to the first boss 54a about the first optical axis along which the first ferrule 64a extends. In alternative embodiments, however, the first ferrule holder 70a and first boss 54a may not include complementary keying features. This may be the case if the end face 66 of the first cap ferrule 64a has ultra physical contact (UPC) polishing geometry, for example.

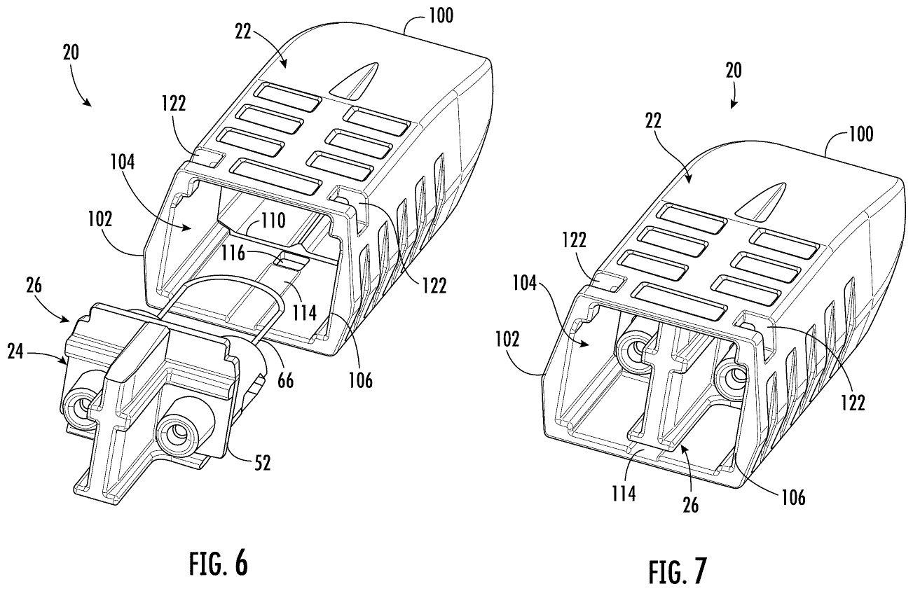

FIGS. 6 and 7 illustrate the insert sub-assembly 26 being installed in the body 22 of the loopback dust cap 20. The body includes a front end 100, a back end 102, and a cavity 104 between the front end 100 and the back end 102. As shown in FIG. 6, the back end 102 includes an opening 106 into the cavity 104. The opening 106 may have a shape/profile that generally corresponds to the shape/profile of the support wall 52 of the insert 24, and the cavity 104 may maintain that shape/profile for at least some length as the cavity 104 extends into the body 22 from the opening 106. In the embodiment shown, the cavity 104 includes an internal ridge or shoulder 110 at a location spaced from the back end 102. The internal shoulder 110 serves as a stop to position the insert sub-assembly 26 in the cavity 104. More specifically, the insert sub-assembly 26 may be passed through the opening 106 and into the cavity 104 until the support wall 52 of the insert 24 contacts the internal shoulder 110, which is configured to prevent further insertion. This results in the arrangement shown in FIG. 7, with the insert sub-assembly 26 properly positioned in the body 22 so that the loopback dust cap 20 can be used with the connector 12.

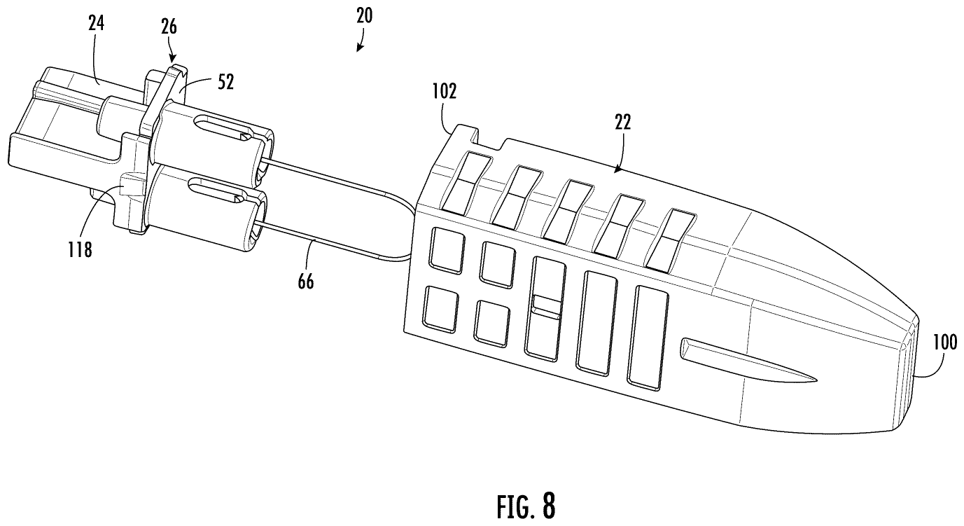

Assembling the components in the manner described above may result in the insert sub-assembly 26 being coupled to the body 22. For example, in the embodiment shown, the body 22 includes a lower channel 114 extending from the back end 102 and a pocket or recess 116 at the end of the lower channel 114. The lower channel 114 accommodates a catch 118 (FIG. 8) that is on a bottom side of the insert 24 when the insert 24 is being inserted into the cavity 104 of the body 22. By the time the insert 24 contacts the internal shoulder 110 of the body 22, the catch 118 is received in the recess 116. The components are designed such that the catch 118 and recess 116 provide a snap-fit coupling between the insert 24 and the body 22. Other ways of implementing a snap-fit are possible, however, as are other forms of coupling in general. For example, in alternative embodiments the insert 24 may be coupled to the body 22 using adhesive, ultrasonic welding, and/or another technique.

Regardless of the coupling technique, when the loopback dust cap 20 is assembled, the body 22 and the insert 24 collectively define an interface for receiving the connector 12 (FIGS. 1 and 2). The interface may correspond to an intermatability interface for the type of connector for which the loopback dust cap 20 is intended. For the embodiment shown, for example, the loopback dust cap 20 may define an LC-type interface according to intermatability standards IEC 61754-20:2012 or TIA-604-10-C. The optical reference plane OP mentioned above in connection with FIG. 3 may therefore correspond to the optical reference plane associated with the intermatability standards IEC 61754-20:2012 or TIA-604-10-C. Cutouts or slots 122 (FIGS. 1 and 2) are also provided in the body 22 of the loopback dust cap 20 at a location that corresponds to a mechanical reference plane associated with the intermatability standards, and thereby define latching features for engaging corresponding latching features 124 on the latch arms 36 of the connector sub-assemblies 30a, 30b.

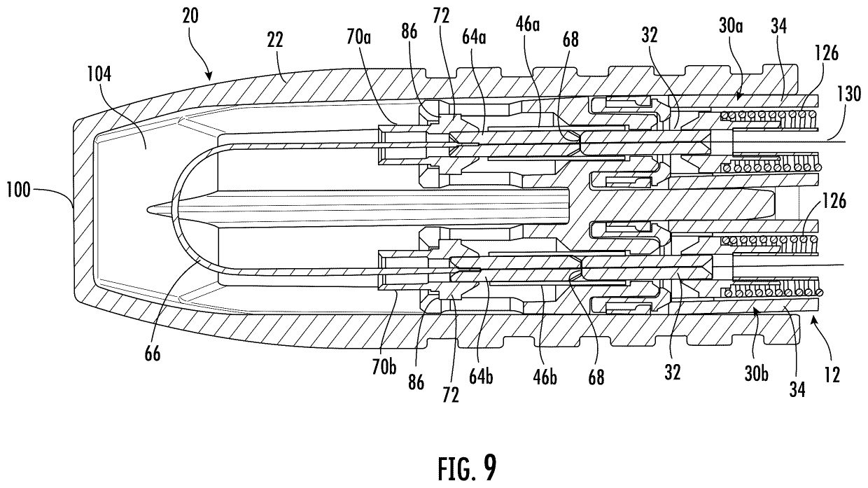

FIG. 9 is a cross-sectional view of the loopback dust cap 20 received on the end of the connector 12. As shown in the figure, the connector ferrules 32 are respectively received in the first and second sleeves 46a, 46b and contact the end faces 68 of the first and second cap ferrules 64a, 64b. More specifically, when placing the loopback dust cap 20 on the connector 12, the connector ferrules 32 enter the respective first and second sleeves 46a, 46b and eventually contact the end faces 66 of the first and second cap ferrules 64a, 64b. The first and second cap ferrules 64a, 64b may be pushed axially by the connector ferrules 32 until the flange portions 72 of the first and second ferrule holders 70a, 70b contact respective internal shoulders 86, which then effectively sets the positions of the first and second cap ferrules 64a, 64b within the loopback dust cap 20 in the manner described above with reference to FIG. 3. The loopback dust cap 20 may still need to be pushed further onto the connector 12 to ensure that the latching features 124 (FIG. 1) of the latch arms 36 engage the corresponding latching features (e.g., slots 122) on the body 22 of the loopback dust cap 20. Because the first and second cap ferrules 64a, 64b prevent the connector ferrules 32 from moving further into the loopback dust cap 20, springs 126 that bias the connector ferrules 32 relative to the connector bodies 34 are compressed to allow the connector bodies 34 to move further into the cavity 104. Eventually the latching features 124 on the latch arms 36 of the connector sub-assemblies 30a, 30b reach a position where they engage the corresponding the latching features on the body 22. Persons skilled in optical connectivity will appreciate how this insertion of the connector 12 into the loopback dust cap 20 and engagement between the components is similar to the insertion of the connector 12 into an adapter (not shown). In alternative embodiments, the first and second cap ferrules 64a, 64b may be spring-biased relative to the insert 22.

FIG. 9 also illustrates how the loopback optical fiber 66 extends between the first and second cap ferrules 64a, 64b in a region of the body 22 that is between the front end 100 of the body 22 and the insert 24. The cavity 104 is still present in this region and accommodates the loopback optical fiber 66. In the embodiment shown, the loopback optical fiber 66 extends axially from the first and second cap ferrules 64a, 64b toward the front end 100 of the body 22 and then makes a single bend so as to have a U-shaped configuration within the cavity 104. The bend therefore has a diameter that approximately corresponds to the pitch between the first and second cap ferrules 64, 64b. Because the pitch between the first and second cap ferrules 64a, 64b may be relatively small (e.g., 6.25 mm for an LC-type interface and even smaller for VSFF embodiments), it may be advantageous for the loopback optical fiber 66 to be an optical fiber with low bend loss. In some embodiments, for example, the loopback optical fiber 66 may be an optical fiber that meets (i.e., achieves or exceeds) the bend performance specifications of International Telecommunication Union standard ITU-T G.657.A2 and/or ITU-T G.657.B2, such as Corning® ClearCurve® LBL optical fiber or Corning® SMF-28® Contour optical fiber. In some embodiments, the loopback optical fiber 66 may even meet the bend performance of International Telecommunication Union standard ITU-T G.657.B3, using for example Corning® ClearCurve® ZBL optical fiber.

In use, the loopback dust cap 20 can function in the manner described at the beginning of this Detailed Description. Specifically, when an optical signal is transmitted by an optical fiber 130 terminated by one of the connector ferrules 32, the optical signal is transmitted to the end of the loopback optical fiber 66 that is terminated by the first or second cap ferrule 36a, 36b (whichever is aligned and in contact with the transmitting connector ferrule 32). The optical signal then travels through the loopback optical fiber 66 so that the loopback assembly 50 directs the optical signal into the optical fiber 130 that is terminated by the other connector ferrule 32. At an opposite end of the optical link that includes the cable assembly 10, the return optical signal can be compared to the transmitted optical signal to evaluate the optical link for attenuation issues.

Instead of or in addition to being used for returning an optical signal to the connector 12, in some embodiments the loopback optical fiber 66 may be configured to scatter or otherwise emit visible light for identification purposes. For example, in some embodiments the body 22 of the loopback dust cap 20 may comprise a translucent or transparent material, such as a polycarbonate. A visual fault locator (VFL; not shown) may be used to deliver optical signals in the form of visible light to the loopback dust cap 20, and the loopback optical fiber 66 may then emit that visible light so that the light that can be seen through the body 22 of loopback dust cap 20. The visible light may even cause the body 22 to glow in some embodiments, thereby further assisting with identification.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The present disclosure in its broader aspects is therefore not limited to the specific details, representative apparatus and methods and illustrative examples shown and described. Accordingly, departures may be made from such details without departing from the scope of the present disclosure.

What is claimed is:

1. A loopback dust cap for a fiber optic cable assembly that includes a first optical fiber, a second optical fiber, and a fiber optic connector having a first connector ferrule that terminates the first optical fiber and a second connector ferrule that terminates the second optical fiber, the loopback dust cap comprising:
a body having a front end, a back end, and a cavity between the front end and the back end, wherein the back end of the body includes an opening into the cavity so that the cavity is configured to receive the fiber optic connector;
an insert received in the cavity of the body;
first and second sleeves supported by the insert and each including a respective first end facing the front end of the body and a respective second end facing the back end of the body;
a first cap ferrule extending through the first end of the first sleeve, wherein the first cap ferrule includes a first end face positioned within the first sleeve;
a second cap ferrule extending through the first end of the second sleeve, wherein second cap ferrule includes a second end face positioned within the second sleeve; and
a loopback optical fiber having a first end terminated by the first cap ferrule and a second end terminated by the cap second ferrule, wherein the loopback optical fiber extends between the first cap ferrule and the second cap ferrule in a region of the body that is between the front end of the body and the insert;
wherein the first sleeve and the second sleeve are configured to:
receive the first connector ferrule and the second connector ferrule, respectively, when the fiber optic connector is received in the cavity of the body, and
align the first connector ferrule and the second connector ferrule with the first cap ferrule and the second cap ferrule, respectively.

2. The loopback dust cap of claim 1, further comprising:
a first ferrule holder received over a portion of the first cap ferrule that is not within the first sleeve; and
a second ferrule holder received over a portion of the second cap ferrule that is not within the second sleeve,
wherein the first ferrule holder and the second ferrule holder are at least partially retained within the insert.

3. The loopback dust cap of claim 2, wherein:
the insert includes a support wall, a first boss extending from the support wall toward the front end of the body, and a second boss extending from the support wall toward the front end of the body;
the first boss extends over and beyond the first end of the first sleeve, and receives and retains at least a portion of the first ferrule holder; and
the second boss extends over and beyond the first end of the second sleeve, and receives and retains at least a portion of the second ferrule holder.

4. The loopback dust cap of claim 3, wherein:
the first boss and the second boss each comprise a respective split end portion configured to expand radially to allow insertion of the first ferrule holder and the second ferrule holder, respectively, when the insert is not received in the cavity, and
the body is configured to limit or prevent the split end portions from expanding radially when the insert is received in the cavity.

5. The loopback dust cap of claim 1, wherein the insert is configured to limit or prevent the first ferrule holder and the second ferrule holder from rotating relative to the insert.

6. The loopback dust cap of claim 1, wherein the insert is coupled to the body by a snap-fit.

7. The loopback dust cap of claim 1, wherein the body includes at least one latching feature configured to engage a corresponding latching feature on the fiber optic connector when the fiber optic connector is received in the cavity.

8. The loopback dust cap of claim 1, wherein the first cap ferrule and the second cap ferrule each comprise a ceramic ferrule having a nominal diameter of 1.25 mm.

9. The loopback dust cap of claim 1, wherein the body and the insert are shaped to define an LC-type interface according to IEC 61754-20:2012 or TIA-604-10-C.

10. The loopback dust cap of claim 1, wherein the first sleeve and the second sleeve each comprise a split sleeve.

11. The loopback dust cap of claim 1, wherein the first cap ferrule and the second cap ferrule are not spring-biased relative to the insert.

12. The loopback dust cap of claim 1, wherein the loopback optical fiber meets bend performance specifications of International Telecommunication Union standard ITU-T G.657.A2 or ITU-T G.657.B2.

13. The loopback dust cap of claim 1, wherein the loopback optical fiber meets bend performance specifications of International Telecommunication Union standard ITU-T G.657.B3.

14. The loopback dust cap of claim 1, wherein the body comprises a translucent or transparent material, and wherein the loopback optical fiber is configured to emit visible light.

15. A fiber optic cable assembly, comprising:
a first optical fiber and a second optical fiber;
a fiber optic connector having a first connector ferrule that terminates the first optical fiber and a second connector ferrule that terminates the second optical fiber; and
a loopback dust cap received on the fiber optic connector, wherein the loopback dust cap includes:
a body having a front end, a back end, and a cavity between the front end and the back end, wherein the back end of the body includes an opening into the cavity;
an insert received in the cavity of the body;
first and second sleeves supported by the insert and each including a respective first end facing the front end of the body and a respective second end facing the back end of the body;
a first cap ferrule extending through the first end of the first sleeve, wherein the first cap ferrule includes a first end face positioned within the first sleeve;
a second cap ferrule extending through the first end of the second sleeve, wherein second cap ferrule includes a second end face positioned within the second sleeve; and
a loopback optical fiber having a first end terminated by the first cap ferrule and a second end terminated by the cap second ferrule, wherein the loopback optical fiber extends between the first cap ferrule and the second cap ferrule in a region of the body that is between the front end of the body and the insert;
wherein:
the first connector ferrule extends into the first sleeve and contacts the end face of the first cap ferrule, and
the second connector ferrule extends into the second sleeve and contacts the end face of the second cap ferrule.

16. The fiber optic cable assembly of claim 15, wherein the loopback dust cap further includes:
a first ferrule holder received over a portion of the first cap ferrule that is not within the first sleeve; and
a second ferrule holder received over a portion of the second cap ferrule that is not within the second sleeve,
wherein the first ferrule holder and the second ferrule holder are at least partially retained within the insert.

17. The fiber optic cable assembly of claim 16, wherein:
the insert of the loopback dust cap includes a support wall, a first boss extending from the support wall toward the front end of the body, and a second boss extending from the support wall toward the front end of the body;
the first boss extends over and beyond the first end of the first sleeve, and receives and retains at least a portion of the first ferrule holder; and
the second boss extends over and beyond the first end of the second sleeve, and receives and retains at least a portion of the second ferrule holder.

18. The fiber optic cable assembly of claim 17, wherein:
the first boss and the second boss each comprise a respective split end portion configured to expand radially to allow insertion of the first ferrule holder and the second ferrule holder, respectively, when the insert is not received in the cavity, and
the body is configured to limit or prevent the split end portions from expanding radially when the insert is received in the cavity.

19. A method of making a loopback dust cap for a fiber optic cable assembly that includes a first optical fiber, a second optical fiber, and a fiber optic connector having a first connector ferrule that terminates the first optical fiber and a second connector ferrule that terminates the second optical fiber, the method comprising:
(a) assembling first and second sleeves with an insert so that the first and second sleeves are supported by the insert;
(b) providing a loopback assembly that includes a loopback optical fiber having one end terminated by a first cap ferrule and another end terminated by a second cap ferrule;
(c) extending the first cap ferrule through a first end of the first sleeve so that an end face of the first cap ferrule is positioned within the first sleeve;
(d) extending the second cap ferrule through a first end of the second sleeve so that an end face of the second cap ferrule is positioned within the second sleeve; and
(e) positioning the insert in a cavity of a body, wherein:
the body includes a front end and a back end,
the back end includes an opening into the cavity, and
the positioning occurs after steps (a)-(d) so that the positioning results in:
the respective first ends of the first and second sleeves facing the front of the body and respective second ends of the first and second sleeves facing the back end of the body, and
the loopback optical fiber extending between the first cap ferrule and the second cap ferrule in a region of the body that is between the front end of the body and the insert,
wherein the cavity of the body is configured to receive the fiber optic connector through the opening in the back end of the body, and
wherein the first sleeve and the second sleeve are configured to:
receive the first connector ferrule and the second connector ferrule, respectively, when the fiber optic connector is received in the cavity, and
align the first connector ferrule and the second connector ferrule with the first cap ferrule and the second cap ferrule, respectively.
